(19) United States
(12) Patent Application Publication
(10) Pub. No.: US 2012/0117555 A1
(43) Pub. Date: May 10, 2012

(54) METHOD AND SYSTEM FOR FIRMWARE ROLLBACK OF A STORAGE DEVICE IN A STORAGE VIRTUALIZATION ENVIRONMENT

(75) Inventors: Arindam Banerjee, Bangalore (IN); Satish Sangapu, Wichita, KS (US)

(73) Assignee: LSI Corporation, Milpitas, CA (US)

(21) Appl. No.: 12/941,221

(22) Filed: Nov. 8, 2010

(51) Int. Cl. G06F 9/44

(52) U.S. Cl. 717/168

(57) ABSTRACT

A method and controller device for upgrading the firmware in a virtualized storage environment having a first storage controller and a second storage controller, wherein each storage controller includes a first virtual machine, at least one second virtual machine and a storage device. The method includes upgrading the current firmware of the first virtual machine in the first storage controller to a new firmware version, upgrading the current firmware of the second virtual machine in the first storage controller to a new firmware version, upgrading the current firmware of the first virtual machine in the second storage controller, upgrading the current firmware of the second virtual machine in the second storage controller, and rolling back the firmware version of all virtual machines in the first and second storage controllers if the firmware upgrade of any of the virtual machines in the first and second storage controllers is not successful.

### BACKGROUND OF THE INVENTION

1. Field of the Invention

The invention relates to storage devices or subsystems within a storage virtualization environment. More particularly, the invention relates to firmware rollback of storage controllers within a storage virtualization environment.

2. Description of the Related Art

Storage virtualization environments typically involve logical space (e.g., a storage subsystem) within a physical (disk) storage system. In a storage virtualization environment where there are multiple virtual machines (VMs) providing separate but dependent storage functions, a firmware update of the individual virtual machines is a relatively complex process. For example, each virtual machine must be upgraded explicitly and from a system level. Also, it is crucial that after a successful or unsuccessful firmware upgrade, all virtual machines are either running the new firmware version or the old firmware version, and not a mix of the two firmware versions. When one or more virtual machines fails the upgrade process, a rollback of firmware should be performed for all of the virtual machines. In general, a firmware rollback is a restoration technique or process in which newly but unsuccessfully installed firmware is removed and the host device or machine is returned to its previous operating state with the previous (old) firmware. In a storage virtualization environment, the ability to perform a relatively seamless rollback of firmware for all virtual machines when one or more virtual machines fails a firmware upgrade process enhances the overall operation and performance of the storage virtualization environment.

Rollback mechanisms are known generally for use in some computing environments. For example, conventional processes exist that are directed to preserving the contents in a data storage unit during a write operation, so that if the write operation fails, the previous contents before the write operation can be restored. Such a rollback mechanism typically preserves a copy of the old data before writing the new data to the data storage unit.

Also, firmware rollback and configuration restoration processes are known for electronic devices, including electronic devices connected via a network. In such processes, a central management system acquires and stores the configuration settings and the current firmware details from an electronic device before attempting to upgrade the firmware of the electronic device. If the firmware upgrade of the electronic device is not successful, the central management system fetches the configuration settings and the previous or original firmware details for restoring to the electronic device.

### SUMMARY OF THE INVENTION

The invention is embodied in a method and controller device for upgrading the firmware in a virtualized storage environment having a first storage controller and a second storage controller, wherein each storage controller includes a first virtual machine, at least one second virtual machine and a storage element. The method includes upgrading the current firmware of the first virtual machine in the first storage controller to a new firmware version, upgrading the current firmware of the second virtual machine in the first storage controller to a new firmware version, upgrading the current firmware of the first virtual machine in the second storage controller to a new firmware version, upgrading the current firmware of the second virtual machine in the second storage controller to a new firmware version, and rolling back the firmware version of all virtual machines in the first storage controller and all virtual machines in the second storage controller from the new firmware version of the respective virtual machine to the current firmware version of the respective virtual machine if the firmware upgrade of any of the virtual machines in the first storage controller or the second storage controller is not successful.

### BRIEF DESCRIPTION OF THE DRAWINGS

FIG. 1 is a schematic view of a virtualized storage environment;

FIG. 2 is a schematic view of the firmware version in the virtual machines in the virtualized storage environment of FIG. 1 before a firmware upgrade, during a firmware upgrade, after a successful firmware upgrade and after an unsuccessful firmware upgrade;

FIG. 3a is a schematic view of the firmware image storage in the flash drive for the virtual machines in the virtualized storage environment of FIG. 1 before a firmware upgrade;

FIG. 3b is a schematic view of the firmware image storage in the flash drive for the virtual machines in the virtualized storage environment of FIG. 1 before a firmware upgrade but after new firmware images are copied to the flash drive;

FIG. 4a is a schematic view of the firmware image storage in the flash drive for the virtual machines in the virtualized storage environment of FIG. 1 during a firmware upgrade;

FIG. 4b is a schematic view of the firmware image storage in the flash drive for the virtual machines in the virtualized storage environment of FIG. 1 after a successful firmware upgrade;

FIG. 4c is a schematic view of the firmware image storage in the flash drive for the virtual machines in the virtualized storage environment of FIG. 1 after an unsuccessful firmware upgrade;

FIG. 5 is a schematic view of the configuration information storage for some of the virtual machines in the virtualized storage environment of FIG. 1;

FIG. 6 is a schematic view of a virtualized storage environment during a firmware upgrade process having a firmware rollback capability according to embodiments of the invention;

FIG. 7 is a block diagram of a method for firmware upgrade with a firmware rollback capability in a storage virtualization environment according to embodiments of the invention; and

FIG. 8 is a schematic view of an apparatus for upgrading the firmware with a firmware rollback capability in a storage virtualization environment according to embodiments of the invention.

### DETAILED DESCRIPTION OF EXEMPLARY EMBODIMENTS

In the following description, like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

As used in this description, the terms “component,” “module,” and “system,” are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes, such as in accordance with a signal having one or more data packets, e.g., data from one component interacting with another component in a local system, distributed system, and/or across a network, such as the Internet, with other systems by way of the signal.

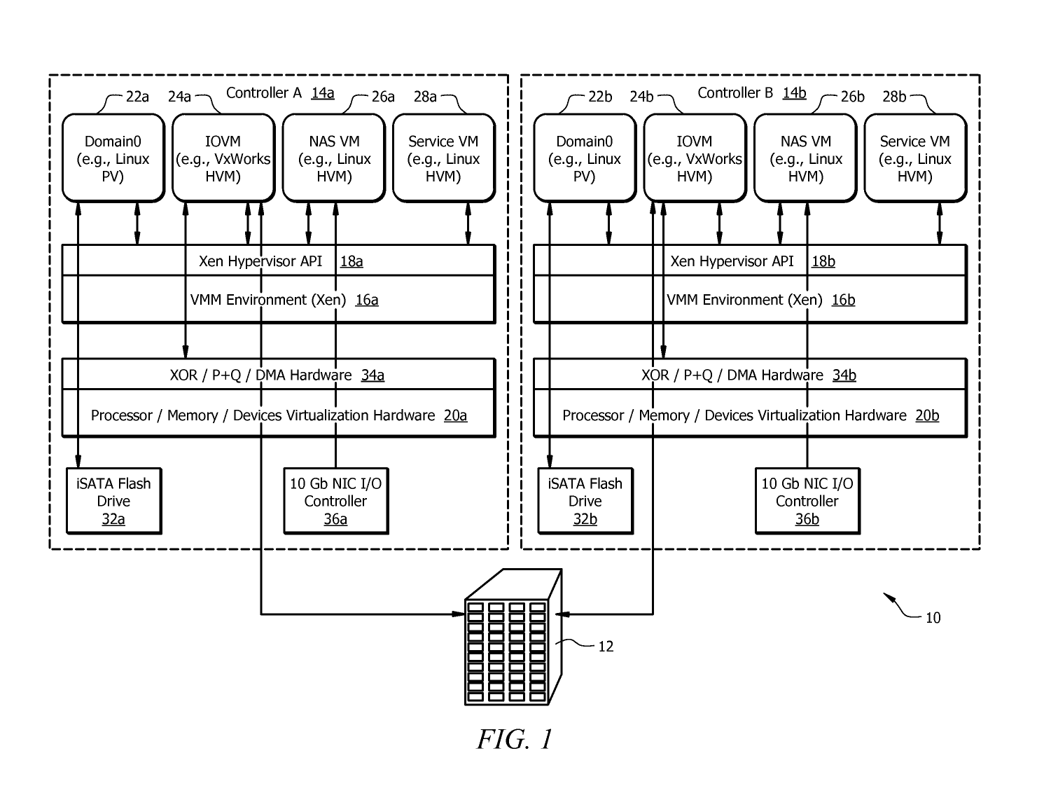

Referring now to FIG. 1, shown is a virtualized storage environment 10. The virtualized storage environment 10 includes a data storage array, typically in the form of a plurality of disk drive units (such as a plurality of Serially attached SCSI (SAS) disk drives) stored within one or more disk drive expansion trays 12. Each data storage array typically includes a first disk array controller or storage controller 14A (Controller A) and a second disk array controller or storage controller 14B (Controller B).

Each storage controller 14 typically includes a Virtual Machine Management (VMM) module 16, which is a software module that abstracts and provisions the hardware resources for the virtual machines (VMs) in each storage controller 14. Xen is an example of a VMM environment or module. The VMM module 16 communicates with all virtual machines in the storage controller 14 via a suitable application program interface (API) 18. Each storage controller 14 also includes the appropriate processor, memory element(s) and device virtualization hardware 20 for proper operation of the storage controller 14.

In many virtualized storage environments 10, the storage controller 14 includes four (4) virtual machines, e.g., a Domain0 (also referred to as Dom0) virtual machine 22, an input/output (IO) virtual machine 24 (IOVM), a Network Attached Storage virtual machine (NAS VM) 26 and a Service virtual machine (Service VM) 28. The Domain0 22 can be a privileged or para-virtualized (PV) virtual machine for Linux or other suitable operating system. Para-virtualized generally describes an Operating System that is modified to run efficiently with Xen. Thus, the Domain0 22 can be a virtual machine that works closely with Xen to provide services for the virtualized storage environment 10. Also, the Domain0 22 owns or controls a storage element or device 32, such as an iSATA (Serial Advanced Technology Attachment) flash drive, within the storage controller 14. The storage device 32 is used for boot images of all the virtual machines.

The IO virtual machine (IOVM) 24 provides RAID (redundant array of inexpensive disks) services for other virtual machines. Therefore, the IOVM 24 has direct access to a suitable direct memory access (DMA) hardware component 34, such as the XOR/P+Q DMA hardware. Also, the IOVM 24 has direct access to the back end disk drives, which typically are located in the disk drive expansion trays 12. The IOVM 24 can be a VxWorks Hardware Virtual Machine (HVM). In general, an HVM is an Operating System that is unmodified and has no knowledge of it being abstracted by a VMM module, e.g., the VMM module 16.

The NAS virtual machine (NAS VM) 26 provides file services and has direct access to a suitable input/output (I/O) controller 36, e.g., the 10 Gb NIC I/O Controller. The NAS VM 26 can be a Linux HVM.

The Service virtual machine (Service VM) 28, e.g., a Linux HVM, is used for systemwide software services, such as providing centralized logging. Another systemwide software service in which the Service VM 28 is used is coordinating firmware updates of the virtual machines.

In this virtualized storage environment 10, when the firmware of the virtual machines is to be upgraded, each virtual machine must be upgraded individually in such a way as to allow the independent function of the other virtual machines to continue while the particular virtual machine is in the process of being upgraded. For example, suppose that a.1 represents the current firmware version for the Domain0 22, b.1 represents the current firmware version for the IOVM 24, c.1 represents the current firmware version for the NAS VM 26, and d.1 represents the current firmware version for the Service VM 28. Also, suppose that a.2 represents the new firmware version for the Domain0 22, b.2 represents the new firmware version for the IOVM 24, c.2 represents the new firmware version for the NAS VM 26, and d.2 represents the new firmware version for the Service VM 28.

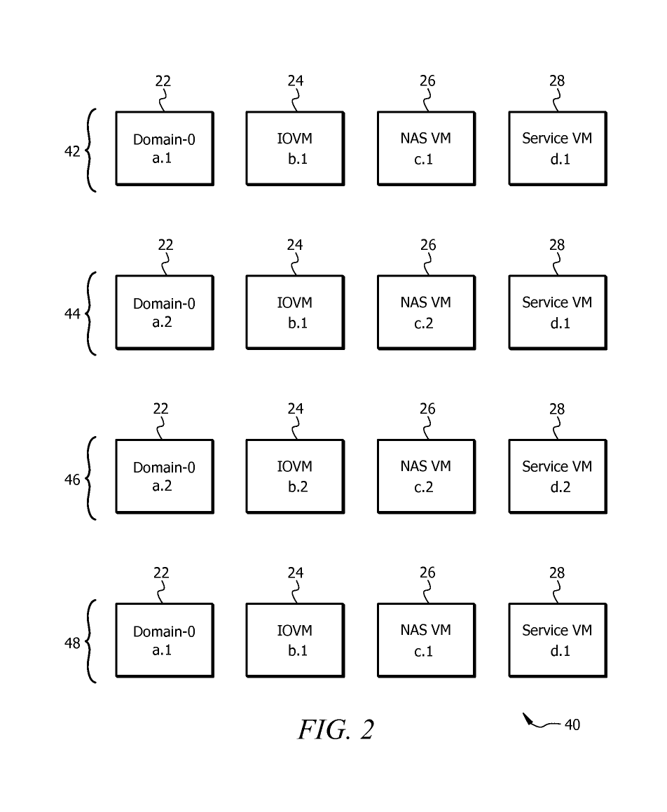

Referring now to FIG. 2, shown is a schematic view of the firmware version in the virtual machines in the virtualized storage environment 10 of FIG. 1 before a firmware upgrade, during firmware upgrade, after a successful firmware upgrade and after an unsuccessful firmware upgrade. It should be noted that although only the virtual machines for a single storage controller (e.g., controller 14A) are shown, a similar layout appears on the peer/alternate storage controller (e.g., controller 14B) after one storage controller has successfully upgraded all of its virtual machines.

A first row 42 of the virtual machines in the storage controller illustrates the firmware versions within each virtual machine before a firmware upgrade. As shown, each of the Domain0 22, the IOVM 24, the NAS VM 26 and the Service VM 28 has its respective current or old firmware version. A second row 44 of the virtual machines in the storage controller illustrates the firmware versions within each virtual machine during an example firmware upgrade process. For example, as shown, during an example firmware upgrade process, the Domain0 22 has a new firmware version (a.2), the IOVM 24 has its old or current firmware version (b.1), the NAS VM 26 has a new firmware version (c.2), and the Service VM 28 has its old or current firmware version (d.1). It should be noted that even though there is a mix of new and old firmware versions during the upgrade process, all virtual machines must either have their respective new firmware version (as shown in a third row 46) or their respective old firmware versions (as shown in a fourth row 48) after the upgrade is completed.

In general, the running/current firmware images are kept in the iSATA flash drive 32, in their own partitions. The running/current firmware images are represented with an active state, which denotes that the running/current firmware image is the current, running image. Just before the firmware upgrade process, the new firmware images are copied into separate, individual partitions in the iSATA flash drive 32, and they are represented with an inactive state. As the firmware upgrade process progresses and the virtual machines are being upgraded, the state of each firmware image is changed in the iSATA flash drive 32.

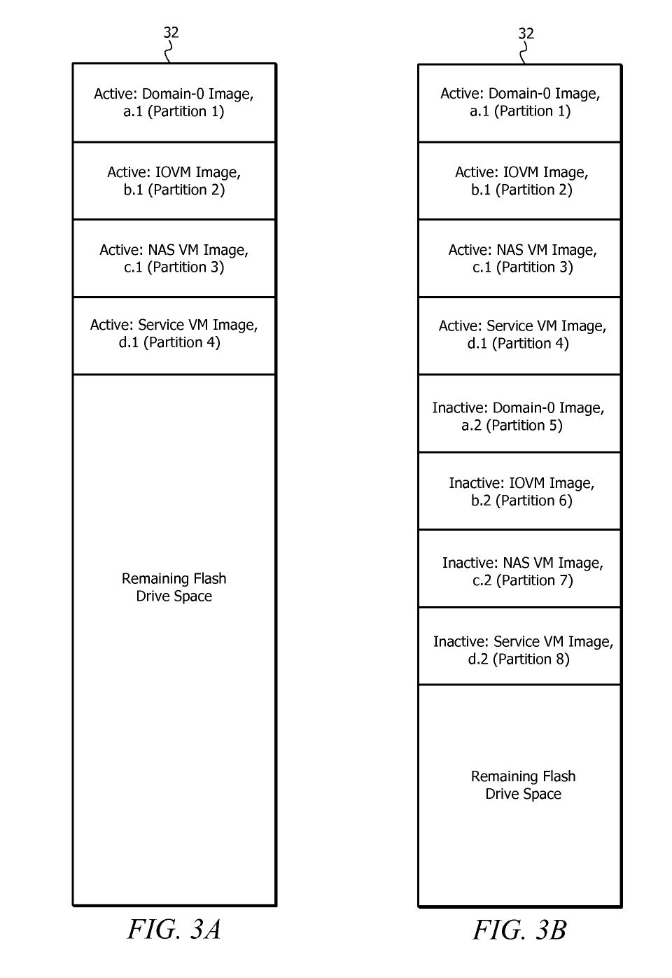

Referring now to FIGS. 3a-b, shown is a schematic view of the firmware image storage in the flash drive 32 for the virtual machines in the virtualized storage environment 10 of FIG. 1, before a firmware upgrade (FIG. 3a) and before a firmware upgrade but after new firmware images are copied to the flash drive 32 (FIG. 3b). The state (active or inactive) of the virtual images in the flash drive 32 also is indicated.

As shown in FIG. 3a, before a firmware upgrade, the current (old) firmware image for each virtual machine is stored in its own partition (e.g., partitions 1-4) in the flash drive 32, and the status of each of the current firmware images is indicated as “active.” As shown in FIG. 3b, before a firmware upgrade but after the current (old) firmware images are copied to the flash drive 32, the new firmware image for each virtual machine also is stored in its own partition (e.g., partitions 5-8) in the flash drive 32, and the status of each of the new firmware images is indicated as “inactive.”

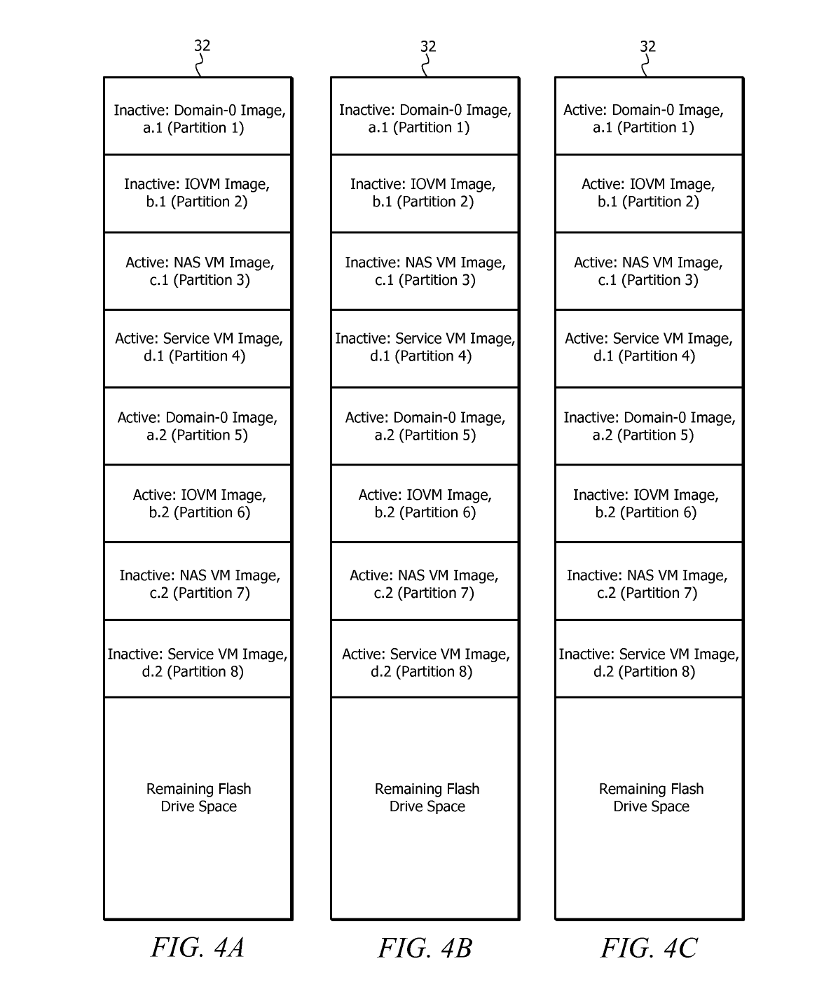

Referring now to FIGS. 4a-c, shown is a schematic view of the firmware image storage in the flash drive 32 for the virtual machines in the virtualized storage environment 10 of FIG. 1, during a firmware upgrade (FIG. 4a), after a successful firmware upgrade (FIG. 4b), and after an unsuccessful firmware upgrade (FIG. 4c). The state of the virtual machine firmware images also is indicated.

As can be seen from FIGS. 4a-4c, the state of the virtual machine firmware images changes between active and inactive in such a way that, after the completion of the firmware upgrade, all virtual machines are either running with the new firmware version or running with the old firmware version, depending on the result of the upgrade operation. That is, after the completion of the firmware upgrade, all virtual machines are running with the new firmware version if the firmware upgrade was successful, or all virtual machines are running with the old firmware version if the firmware upgrade was not completely successful. For example, during the firmware upgrade process (FIG. 4a), some of the old firmware versions are in an inactive state and some of the old firmware versions are in an active state. Also, in a complementary manner, some of the new firmware versions are in an active state and some of the new firmware versions are in an inactive state. However, once the firmware upgrade is complete, all of the old firmware versions are either in an inactive state (after a successful firmware upgrade—FIG. 4b) or in an active state (after an unsuccessful firmware upgrade—FIG. 4c). Also, in a complementary manner, once the firmware upgrade is complete, all of the new firmware versions are either in an active state (after a successful firmware upgrade—FIG. 4b) or in an inactive state (after an unsuccessful firmware upgrade—FIG. 4c).

In general, this firmware upgrade scheme is suitable for the process of upgrading the firmware version of the virtual machines in a virtualized storage environment. However, persisted configuration information for the virtual machines also should be considered as well. Persisted configuration information generally is described as any saved state information that is used to start up or run the system.

In the virtualized storage environment 10 of FIG. 1, the virtual machines have persisted configuration information that they store in various formats. For example, the Domain0 22 stores configuration files that are needed to boot (e.g., networking settings and user permissions) in flash storage, such as the flash drive 32. The IOVM 24 stores configuration information on a portion of the storage device (e.g., the last 0.50 GB of storage) on each drive in the system. Such storage device portion is referred to as Stable Storage, and the data can be stored by using an N-way mirror algorithm. Also, a block virtualization layer (BVL) within the IOVM 24 uses a RAID volume (called a Setup Volume) to store its configuration information. The RAID volumes typically are stored on the back-end SAS drives. The NAS VM 26 has a cluster database, called Ubik, which is stored in flash memory, such as the flash drive 32. Also, the Service VM 28 has configuration information (e.g., log volumes) that are stored on the RAID volume.

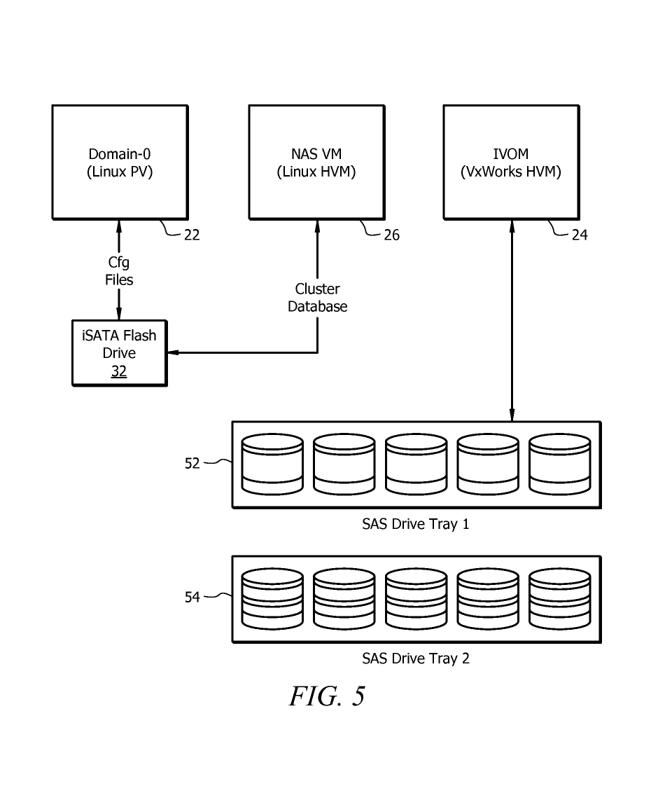

Referring now to FIG. 5, shown is a schematic view of the configuration information storage for some of the virtual machines in the virtualized storage environment 10 of FIG. 1. As just discussed, the Domain-0 22 stores its configuration files on the flash drive 32, the NAS VM 26 stores its cluster database on the flash drive 32, and the IOVM 24 stores its Stable Storage configuration information and Setup Volume configuration information on the back-end SAS drives, which are shown as a first SAS drive tray 52 and a second SAS drive tray 54. As discussed hereinabove, the back-end SAS drives typically are located within one or more disk drive expansion trays 12 (shown in FIG. 1).

In the virtualized storage environment 10 of FIG. 1, three of the four virtual machines have critical configuration information, which generally is defined as information that would lead to a complete halt of the virtualized system that is serving multiple functions if that configuration information was corrupted or erased. More specifically, the Domain-0 22 has critical information in the form of networking settings and user permissions, the IOVM 24 has critical information in the form of Stable Storage and Setup Volume configuration information, and the NAS VM 26 has critical information in the form of cluster database configuration information.

Configuration information typically is classified into one of two areas: (1) state information about the existing, configured features, and (2) critical system information, such as failures of disk drives or volumes. This persisted configuration information is written out to a storage device with some specific layout or schema. For example, the Domain-0 22 has its layout for its configuration files. Similarly, the NAS VM 26 has a particular layout for its cluster database, and the IOVM 24 has its particular layout for its Stable Storage and Setup Volume. With respect to a firmware upgrade, if the new firmware version results in a different configuration layout or schema for any of the virtual machines, then a firmware rollback of that virtual machine is problematic because the underlying layout of the configuration storage has significantly changed to the extent that undoing or rolling back the firmware version becomes a relatively complex if not impossible task.

According to embodiments of the invention, firmware upgrades of virtual machines within a virtualized storage environment are performed in such a manner that, if any firmware rollback occurs, all virtual machines in the virtualized storage environment are running a consistent firmware version. In this manner, both the firmware versions and the associated configuration information of the virtual machines are consistent. Furthermore, the firmware or firmware version rollback is consistent despite possible layout/schema updates of the configuration information and multiple scheme updates for the various, independent virtual machines in the virtualized storage environment.

According to embodiments of the invention, the flash drive 32 of each controller 14 (or other appropriate storage device or element) is used to store the configuration information of the older (current) firmware version for each virtual machine. The particular virtual machine's existing or normal storage element that is used for storing current configuration information also is used to store the configuration information of the new firmware version. Also, according to embodiments of the invention, both copies of the configuration information are updated when critical system information needs to be persisted, because critical system information is necessary if the firmware upgrade succeeds or fails. Because the configuration information of the current (old) firmware version is copied to both flash drives 32 (one flash drive 32 on each controller 14), the firmware upgrade can continue even if one of the flash drives 32 fails. However, the storage of the configuration information can be simplified if the particular configuration storage layouts or schemes are not updated for any of the virtual machines, as long as the storage applications do not allow any feature modifications during the firmware upgrade.

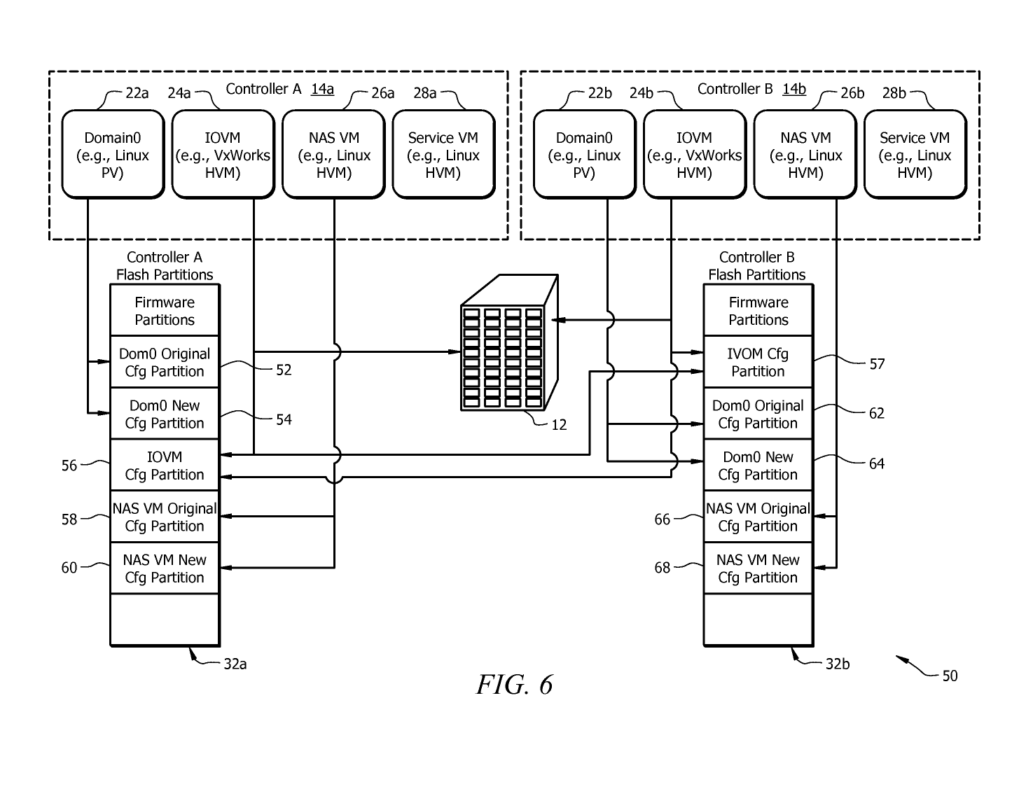

Referring now to FIG. 6, shown is a schematic view of a virtualized storage environment 50 during a firmware upgrade process that includes a firmware version rollback capability, according to embodiments of the invention. The virtualized storage environment 50 includes a first controller A and a second controller B, such as the storage controller 14A and the storage controller 14B, respectively, shown in FIG. 1. As discussed hereinabove, the storage controller 14A typically includes four virtual machines: the Domain0 virtual machine 22A, the IO virtual machine (IOVM) 24A, the NAS virtual machine (NAS VM) 26A and the Service virtual machine (Service VM) 28A. Similarly, the storage controller 14B typically includes four virtual machines: the Domain0 virtual machine 22B, the IO virtual machine (IOVM) 24B, the NAS virtual machine (NAS VM) 26B and the Service virtual machine (Service VM) 28B. The virtualized storage environment 50 also includes a data storage array, such as the disk drive expansion trays 12. Each of the storage controllers 14 in the virtualized storage environment 50 also includes other components, hardware and software (not shown) that are used for the operation of other features and functions of the storage controllers 14 not specifically described herein.

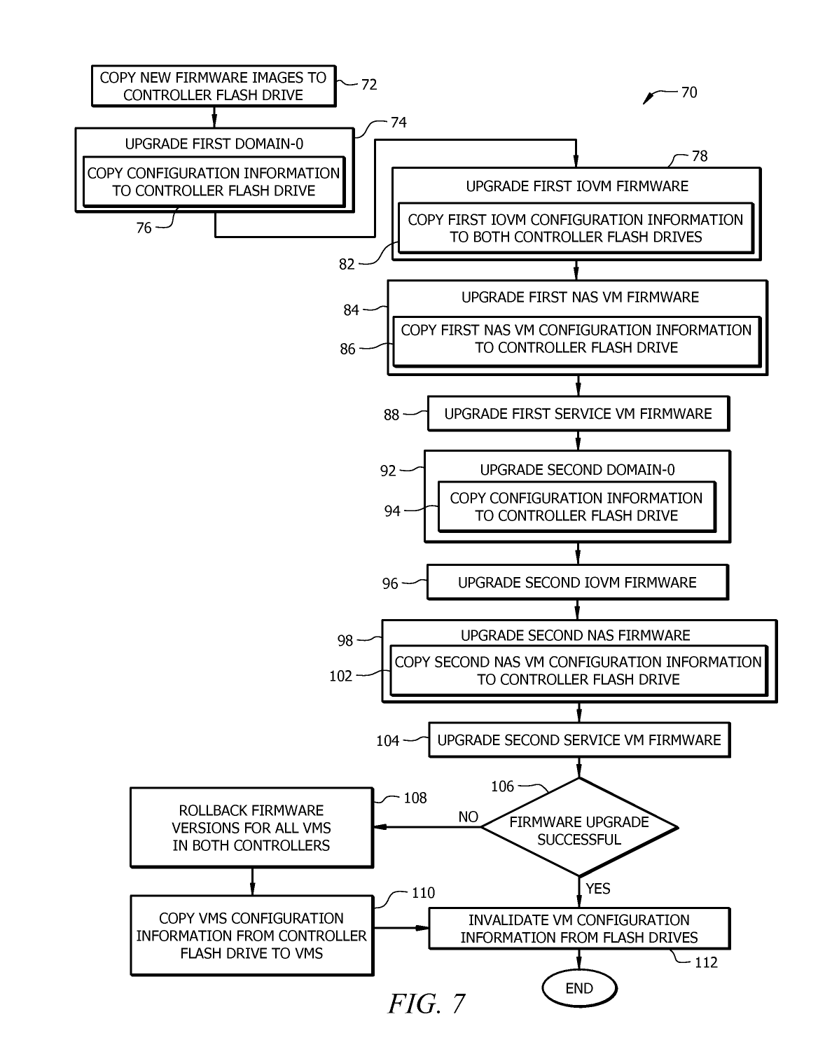

Referring now to FIG. 7, with continuing reference to FIG. 6, shown is a block diagram 70 of a method for upgrading firmware in a storage virtualization environment, according to embodiments of the invention. The method 70 includes a step 72 of copying the new firmware images to the flash drive 32 within each storage controller 14. As discussed hereinabove and shown in FIGS. 3a-b, before a firmware upgrade, the current (old) firmware image for each virtual machine in a storage controller 14 is stored in its own partition in the flash drive 32 in the respective storage controller 14. Also, before a firmware upgrade but after the current (old) firmware images are copied to the flash drive 32, the new firmware image for each virtual machine in each storage controller 14 also is stored in its own partition in the flash drive 32 in the respective storage controller 14.

The method 70 also includes a step 74 of upgrading the firmware of the first Domain0 virtual machine 22A in the storage controller 14A. As part of this firmware upgrade, initially, a step 76 of copying the configuration information for the Domain0 virtual machine 22A to a partition in the flash drive 32A is performed. For example, the current (original) configuration information for the Domain0 virtual machine 22A is copied to a first partition 52 of the flash drive 32A, and the new configuration information for the Domain0 virtual machine 22A is copied to a second partition 54 of the flash drive 32A. Once the configuration information has been copied, any critical state information that occurs also is copied to both of the partitions 52, 54 of the flash drive 32A. Such copying of critical state information is done transactionally, i.e., in such a manner that the critical state information update is successful if writes to both partitions 52, 54 are successful. If the critical state information update fails to one of the partitions 52, 54, then it must fail for both partitions 52, 54. This is to ensure that the critical state information is consistent between the two views.

The method 70 also includes a step 78 of upgrading the firmware of the first IOVM 24A in the first controller 14A. After the firmware upgrade of the first Domain0 virtual machine 22A in the controller 14A, the firmware upgrade for the first IOVM 24A in the first controller 14A begins. When the firmware upgrade for the first IOVM 24A starts, a copying step 82 is performed in which the IOVM Stable Storage and Setup Volume configuration information of the first IOVM 24A and the second IOVM 24B are copied from the SAS drives into a first separate partition 56 on the flash drive 32A and into a second separate partition 57 on the second flash drive 32B.

Once this configuration information copying has occurred, any critical state information that is updated in the Stable Storage or the Setup Volume from the first storage controller 14A or the second storage controller 14B also is updated in the appropriate partition of both flash drives 32. Therefore, even if the second IOVM 24B has a critical state information update, that critical state information update also must be reflected in the first partition 56 on the first flash drive 32A in the first storage controller 14A. Likewise, if the first IOVM 24A has a critical state information update, that critical state information update also must be reflected in the second partition 57 on the second flash drive 32B in the second storage controller 14B. This update process is a different procedure than that for the first Domain0 virtual machine 22A, because Stable Storage and Setup Volume configuration information (which reside on the back-end SAS drives) share the same configuration information for both the first storage controller 14A and the second storage controller 14B.

As a result of the copying step 82, a data write to the Stable Storage or Setup Volume configuration information from either storage controller 14 will make it to the first flash drive 32A on the first controller 14A as well as the second flash drive 32B on the second controller 14B. This copying process is controlled by a mirror that resides in the Domain0 virtual machine 22. More specifically, when the second IOVM 24B updates the Stable Storage or the Setup Volume with critical state information, the second IOVM 24B invokes the mirror in the second Domain022B to update both the first flash drive 32A and the second flash drive 32B. The mirror that resides in the second Domain0 virtual machine 22B updates the write in its flash drive 32B and then mirrors that write to the associated partition in the first flash drive 32A of the first controller 14A. The mirror in each Domain0 virtual machine 22 is bi-directional so that critical state updates that are made (through either controller) are transactionally updated to both flash drives 32A, 32B.

The method 70 also includes a step 84 of upgrading the firmware of the NAS VM 26A in the first controller 14A. As part of this firmware upgrade, initially, a step 86 is performed in which the configuration information for the NAS VM 26A (i.e., the cluster database) is copied from the flash drive 32A to a separate partition in the flash drive 32A. For example, the current (original) configuration information for the NAS VM 26A is copied to a partition 58 of the flash drive 32A, and the new configuration information for the NAS VM 26A is copied to a partition 60 of the flash drive 32A. Therefore, the configuration information for the NAS VM 26A resides on the flash drive 32A only. Also, both the current (original) configuration information for NAS VM 26A and the new configuration information for the NAS VM 26A are updated for critical system events. Also, the configuration information copies between the two partitions 58, 60 are performed transactionally, i.e., in such a manner that the critical state information update is successful only if writes to both partitions 58, 60 are successful.

The method 70 also includes a step 88 of upgrading the firmware of the first Service VM 28A in the first controller 14A. After the firmware upgrade of the first NAS VM 26A is performed, the firmware upgrade for the first Service VM 28A in the first controller 14A is performed.

The method 70 also includes a step 92 of upgrading the firmware of the second Domain0 virtual machine 22B in the second storage controller 14B. Once the first storage controller 14A has finished upgrading all of its virtual machines, the second storage controller 14B begins the firmware upgrade of all of its virtual machines. As part of the firmware upgrade of the second Domain0 virtual machine 22B, initially, a step 94 of copying the configuration information for the second Domain0 virtual machine 22B to a partition in the flash drive 32B is performed. For example, the current (original) configuration information for the second Domain0 virtual machine 22B is copied to a first partition 62 of the flash drive 32B, and the new configuration information for the second Domain0 virtual machine 22B is copied to a second partition 64 of the flash drive 32B. Similar to the process associated with the first Domain0 virtual machine 22A, any critical state information that occurs is updated to both the first partition 62 and the second partition 64 in the second flash drive 32B.

It should be noted that the configuration information that the first Domain0 22A stores on the first flash drive 32A in the first storage controller 14A can be different than the configuration information that the second Domain0 22B stores on the second flash drive 32B in the second storage controller 14B. Therefore, there are separate individual secondary copies of that data between the storage controllers.

The method 70 also includes a step 96 of upgrading the firmware of the second IOVM 24B in the second controller 14B. After the firmware upgrade of the second Domain0 22B in the second storage controller 14B is completed, the firmware upgrade for the second IOVM 24B in the second storage controller 14B begins. When the firmware upgrade for the second IOVM 24B starts, only the firmware version portion of the upgrade process is invoked, and not the configuration information portion of the process. As discussed hereinabove, the IOVM configuration information (Stable Storage and Setup Volume) of both IOVMs was copied to both flash drives during the copying step 82.

The method 70 also includes a step 98 of upgrading the firmware of the second NAS VM 26B in the second storage controller 14B. As part of this firmware upgrade, initially, a copying step 102 is performed in which the cluster database configuration information for the second NAS VM 26B is copied from the second flash drive 32B to a separate partition in the second flash drive 32B. More specifically, the current (original) configuration information for the second NAS VM 26B is copied to a first partition 66 of the second flash drive 32B, and the new configuration information for the NAS VM 26B is copied to a second partition 68 of the second flash drive 32B. Like the NAS VM 26A, the cluster database configuration information for the second NAS VM 26B resides only on its respective flash drive, i.e., the second flash drive 32B. Also, both the current (original) configuration information for the second NAS VM 26B and the new configuration information for the second NAS VM 26B are updated for critical system events. Also, the configuration information copies between the two partitions 66, 68 are performed transactionally. Also, it should be noted that updates for the cluster database configuration information for each NAS VM 26 are peered to the alternate storage controller 14 (i.e., the first storage controller 14A) using the underlying NAS VM 26 cluster database configuration information peering mechanisms only. Hence, there is no need to explicitly invoke the mirror for peering purposes.

The method 70 also includes a step 104 of upgrading the firmware of the second Service VM 28B in the second controller 14B. After the firmware upgrade of the second NAS VM 26B is completed, the firmware upgrade for the second Service VM 28B in the second controller 14B is performed.

The method 70 includes a step 106 of determining whether the firmware upgrade for all of the virtual machines in the first storage controller 14A and the firmware upgrade for all of the virtual machines in the second storage controller 14B was successful. If the firmware upgrade for any virtual machines in either of the storage controllers 14 was not successful (N), the method 70 performs a firmware rollback step 108 in which the firmware versions for all virtual machines in both storage controllers 14 are rolled back to their respective original (old) firmware versions. Also, the method 70 includes a configuration information rollback step 110, in which the original configuration information is restored for each virtual machine in each storage controller 14. That is, the second copy of the original (old) configuration information for each virtual machine (stored in its controller's respective flash drive 32) is copied to the appropriate configuration storage location for each individual virtual machine.

The method 70 also includes a step 112 in which the second copies of the virtual machine configuration information that are stored in the various partitions within the first flash drive 32A and the second flash drive 32B are invalidated or erased. Once an unsuccessful firmware upgrade process has been identified, and a firmware rollback has been performed (step 108), and the original configuration information restored for the virtual machine (step 110), the second copies of the original configuration information for the virtual machines are invalidated or erased from both flash drives 32A, 32B.

If the firmware upgrade for all virtual machines in both storage controllers 14 was successful (Y), the method 70 does not perform a firmware rollback, but instead directly performs the step 112 of invalidating or erasing the second copies of the virtual machine configuration information stored in both flash drives 32A, 32B.

According to alternative embodiments of the invention, firmware rollback is possible even if the firmware upgrade is successful. However, this capability does involve the critical state information being updated in both copies, even after the new firmware upgrade has been completed. Therefore, according to alternative embodiments of the invention, such firmware rollback capability can be available for a trail time period, e.g., for a particular number of days. This allows a user to try out the new firmware upgrade before deciding whether or not to keep the firmware upgrade. After the trial time period expires, the second copies in the flash drives 32 are invalidated or discarded, which will result in better system performance of the overall virtualized storage environment.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter,” “then,” “next,” and other similar words are not intended to limit the order of the steps. These words simply are used to guide the reader through the description of the exemplary method. Also, one of ordinary skill in programming will be able to write computer code or identify appropriate hardware and/or circuits to implement the disclosed invention without difficulty, based on the flow charts and associated description in this specification. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures, which may illustrate various process flows.

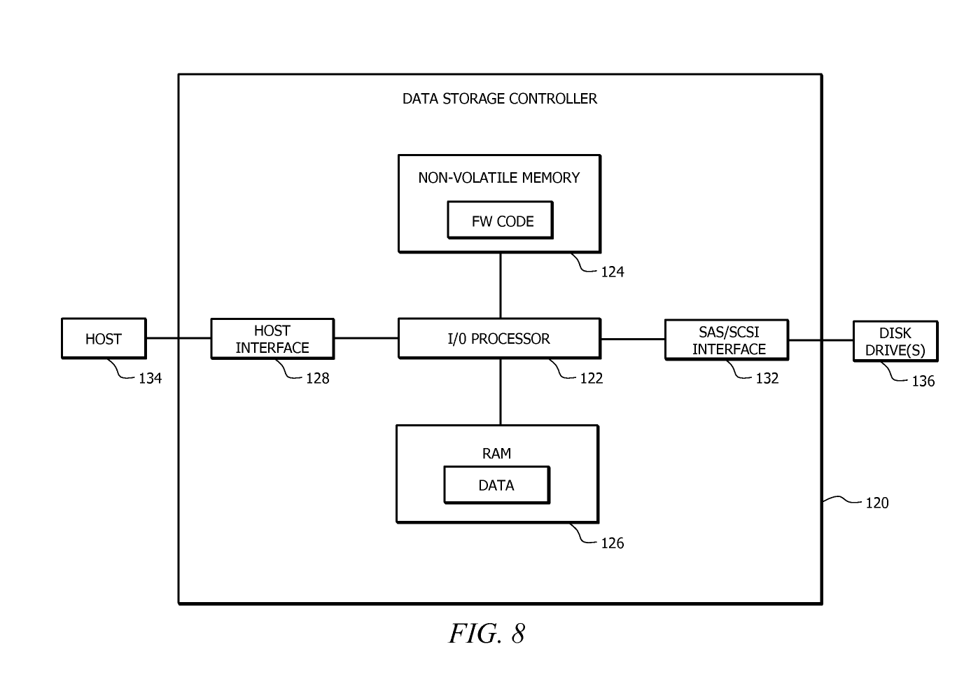

Referring now to FIG. 8, shown is a schematic view of a storage controller or controller device or apparatus 120 according to embodiments of the invention. The storage controller 120, such as one or both of the first storage controller 14A (Controller A) and the second storage controller 14B (Controller B), manages the operation of an associated data storage device, including reading data from and writing data to the data storage device, which can be a storage array, such as a Redundant Array of Inexpensive Disks (RAID) storage array. For example, the storage controller 120 processes requests from a host system attached thereto into appropriate requests to the data storage device.

The storage controller 120 includes an input/output (I/O) processor 122, a non-volatile memory element 124 typically having firmware code programmed therein, a random access memory (RAM) element 126 typically having various data at least temporarily stored therein, a front-end or host interface 128, and one or more back-end or data storage device interfaces 132, such as a Serial Attached SCSI (SAS)/SCSI interface. The host interface 128, which interfaces with a host system 134, allows communication between the storage controller 120 and the host system 134. The SAS/SCSI interface 132, which interfaces with one or more disk drives 136 or other data storage device, such as a RAID storage array, allows data communication between the storage controller 120 and the disk drives 136.

The storage controller 120 can include any suitable conventional elements, such as microprocessors, memory and hard-wired logic, that in accordance with suitable programming or configuration logic allow the storage controller 120 to effect the functions or methods described herein, as well as any other suitable functions that persons skilled in the art understand are characteristic of conventional storage controllers. Such programming logic can be stored in the form of software or firmware that has been loaded into memory for execution by one or more processors, either on an as-needed or random-access basis or as firmware stored in non-volatile memory (e.g., programmable read-only memory).

One or more of the components within the storage controller 120, including the input/output (I/O) processor 122, the non-volatile memory element 124, the random access memory (RAM) element 126, the host interface 128, and the back-end interfaces 132, can be comprised partially or completely of any suitable structure or arrangement, e.g., one or more integrated circuits. Also, it should be understood that the storage controller 120 includes other components, hardware and software (not shown) that are used for the operation of other features and functions of the storage controller 120 not specifically described herein.

The storage controller 120 can be partially or completely configured in the form of hardware circuitry and/or other hardware components within a larger device or group of components. Alternatively, the storage controller 120 can be partially or completely configured in the form of software, e.g., as processing instructions and/or one or more sets of logic or computer code. In such configuration, the logic or processing instructions typically are stored in a data storage device (not shown). The data storage device typically is coupled to a processor, such as the I/O processor 122. The processor accesses the necessary instructions from the data storage device and executes the instructions or transfers the instructions to an appropriate location within the storage controller 120.

As discussed hereinabove, the storage controller 120 typically is programmed with read-only memory (ROM) images that contain various firmware, e.g., one or more firmware images, such as a RAID firmware image. These firmware images include various sub-modules that are executed by various hardware portions of the storage controller during the operation of the storage controller 120.

In one or more aspects, the functions described may be implemented in hardware, software, firmware, or any combination thereof. If implemented in software, the functions may be stored on or transmitted as one or more instructions or code on a non-transitory computer-readable medium. Non-transitory computer-readable media includes both computer storage media and communication media including any tangible medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other tangible medium that may be used to carry or store desired program code in the form of instructions or data structures and that may be accessed by a computer.

It will be apparent to those skilled in the art that many changes and substitutions can be made to the embodiments of the invention herein described without departing from the spirit and scope of the invention as defined by the appended claims and their full scope of equivalents.

1. A method for upgrading firmware in a virtualized storage environment having a first storage controller and a second storage controller, wherein each storage controller includes a first virtual machine, at least one second virtual machine and a storage device, the method comprising:
upgrading the current firmware of the first virtual machine in the first storage controller to a new firmware version;
upgrading the current firmware of the second virtual machine in the first storage controller to a new firmware version;
upgrading the current firmware of the first virtual machine in the second storage controller to a new firmware version;
upgrading the current firmware of the second virtual machine in the second storage controller to a new firmware version; and
rolling back the firmware version of all virtual machines in the first storage controller and all virtual machines in the second storage controller from the new firmware version of the respective virtual machine to the current firmware version of the respective virtual machine if the firmware upgrade of any of the virtual machines in either of the first storage controller or the second storage controller is not successful.

2. The method as recited in claim 1, wherein at least one virtual machine in a storage controller has original configuration information associated therewith and new configuration information associated therewith, and wherein the method includes, before upgrading the current firmware of the virtual machine in the storage controller, storing the original current configuration information associated with the virtual machine in the storage device in the storage controller of the virtual machine and storing the new configuration information associated with the virtual machine in the storage device in the storage controller of the virtual machine.

3. The method as recited in claim 2, wherein rolling back the firmware version of a virtual machine in a storage controller includes replaying the current configuration information associated with the virtual machine.

4. The method as recited in claim 2, wherein the second virtual machine is an input/output virtual machine (IOVM), and wherein storing configuration information associated with the IOVM includes storing configuration information associated with the IOVM of the first storage controller and configuration information associated with the IOVM of the second storage controller in the storage device of the first storage controller and in the storage device of the second storage controller.

5. The method as recited in claim 1, wherein upgrading the current firmware version of a virtual machine on a storage controller includes storing an image of the current firmware version of the virtual machine in the storage device of the storage controller, storing an image of the new firmware version of the virtual machine in the storage device of the storage controller, and, when the firmware of the virtual machine is being upgraded, deactivating the image of the current firmware version of the virtual machine and activating the image of the new firmware version.

6. The method as recited in claim 1, wherein, when the current firmware version of a virtual machine is being upgraded with the new firmware version of the virtual machine, no other virtual machine is upgraded.

7. The method as recited in claim 1, wherein the method includes rolling back the firmware version of all virtual machines in the first storage controller and all virtual machines in the second storage controller even if the firmware upgrades of all of the virtual machines in the first storage controller and the second storage controller are successful.

8. The method as recited in claim 1, wherein the first virtual machine is a Domain0 virtual machine, and wherein the at least one second virtual machine is an input/output virtual machine (IOVM), an NAS virtual machine (NAS VM) and a Service virtual machine (Service VM).

9. The method as recited in claim 1, wherein at least one of the storage devices in the first storage controller and the second storage controller is a flash drive.

10. A storage controller device, comprising:
an interface configured to couple the storage controller device to at least one data storage device; and
a processor coupled to the interface and configured to read data from and write data to the at least one data storage device,
wherein the storage controller device includes a first storage controller and a second storage controller, wherein each storage controller hosts a virtualized storage environment having a first virtual machine, at least one second virtual machine and a storage device;
wherein the storage controller device is configured to
upgrade the current firmware of the first virtual machine in the first storage controller to a new firmware version,
upgrade the current firmware of the second virtual machine in the first storage controller to a new firmware version,
upgrade the current firmware of each virtual machine in the first storage controller to a new firmware version individually in such a manner that allows the other virtual machines in the first storage controller not being upgraded to continue operating,
upgrade the current firmware of each virtual machine in the second storage controller to a new firmware version individually in such a manner that allows the other virtual machines in the second storage controller not being upgraded to continue operating,
roll back the firmware version of all virtual machines in the first storage controller and all virtual machines in the second storage controller from the new firmware version of the respective virtual machine to the current firmware version of the respective virtual machine if the firmware upgrade of any of the virtual machines in the first storage controller or the second storage controller is not successful.

11. The device as recited in claim 10, wherein at least one virtual machine on a storage controller has original configuration information associated therewith and new configuration information associated therewith, and wherein the controller is configured to, before upgrading the current firmware of the virtual machine on the storage controller, store the original current configuration information associated with the virtual machine in the storage device in the storage controller of the virtual machine and store the new configuration information associated with the virtual machine in the storage device in the storage controller of the virtual machine.

12. The device as recited in claim 11, wherein the controller rolling back the firmware version of a virtual machine in a storage controller includes the controller replaying the current configuration information associated with the virtual machine.

13. The device as recited in claim 11, wherein the second virtual machine is an input/output virtual machine (IOVM), and wherein the controller storing configuration information associated with the IOVM includes the controller storing configuration information associated with the IOVM of the first storage controller and configuration information associated with the IOVM of the second storage controller in the storage device of the first storage controller and in the storage device of the second storage controller.

14. The device as recited in claim 10, wherein the controller upgrading the current firmware version of a virtual machine on a storage controller includes the controller storing an image of the current firmware version of the virtual machine in the storage device of the storage controller, the controller storing an image of the new firmware version of the virtual machine in the storage device of the storage controller, and, when the firmware of the virtual machine is being upgraded, the controller deactivating the image of the current firmware version of the virtual machine and activating the image of the new firmware version.

15. The device as recited in claim 10, wherein, when the controller is upgrading the current firmware version of a virtual machine with the new firmware version of the virtual machine, the controller is not upgrading any other virtual machine.

16. The device as recited in claim 10, wherein the controller is configured to roll back the firmware version of all virtual machines in the first storage controller and all virtual machines in the second storage controller even if the firmware upgrades of all of the virtual machines in the first storage controller and the second storage controller are successful.

17. The device as recited in claim 10, wherein the first virtual machine is a Domain0 virtual machine and wherein the at least one second virtual machine is an input/output virtual machine (IOVM), an NAS virtual machine (NAS VM) and a Service virtual machine (Service VM).

18. A non-transitory computer readable medium storing instructions that carry out a method for upgrading firmware in a virtualized storage environment having a first storage controller and a second storage controller, wherein each storage controller includes a first virtual machine, at least one second virtual machine and a storage device, the non-transitory computer readable medium comprising:
instructions for upgrading the current firmware of the first virtual machine in the first storage controller to a new firmware version;
instructions for upgrading the current firmware of the second virtual machine in the first storage controller to a new firmware version;
instructions for upgrading the current firmware of the first virtual machine in the second storage controller to a new firmware version;
instructions for upgrading the current firmware of the second virtual machine in the second storage controller to a new firmware version; and
instructions for rolling back the firmware version of all virtual machines in the first storage controller and all virtual machines in the second storage controller from the new firmware version of the respective virtual machine to the current firmware version of the respective virtual machine if the firmware upgrade of any of the virtual machines in the first storage controller or the second storage controller is not successful.

19. The non-transitory computer readable medium as recited in claim 18, wherein at least one virtual machine on a storage controller has original configuration information associated therewith and new configuration information associated therewith, and wherein the computer readable medium includes, instructions for storing the current configuration information associated with the virtual machine in the storage device in the storage controller of the virtual machine and instructions for storing the new configuration information associated with the virtual machine in the storage device in the storage controller of the virtual machine before carrying out the instructions for upgrading the current firmware of the virtual machine on the storage controller.

20. The non-transitory computer readable medium as recited in claim 18, wherein upgrading the current firmware version of a virtual machine on a storage controller includes instructions for storing an image of the current firmware version of the virtual machine in the storage device of the storage controller, instructions for storing an image of the new firmware version of the virtual machine in the storage device of the storage controller, and, when the firmware of the virtual machine is being upgraded, instructions for deactivating the image of the current firmware version of the virtual machine and instructions for activating the image of the new firmware version.
